(19) United States
(12) Patent Application Publication
(10) Pub. No.: US 2022/0245516 A1
(43) Pub. Date: Aug. 4, 2022

(54) Method, System, and Computer Program Product for Multi-Task Learning in Deep Neural Networks

(71) Applicant: Visa International Service Association, San Francisco, CA (US)

(72) Inventors: Xi Kan, Austin, TX (US); Sheng Wang, Austin, TX (US); Yiwei Cai, Mercer Island, WA (US); Pei Yang, Austin, TX (US); Gourab Basu, Half Moon Bay, CA (US); Michael Mori, San Mateo, CA (US); Rajat Das, San Mateo, CA (US)

(21) Appl. No.: 17/590,249

(22) Filed: Feb. 1, 2022

Related U.S. Application Data
(60) Provisional application No. 63/144,164, filed on Feb. 1, 2021.

(51) Int. Cl. G06N 20/00

(52) U.S. Cl. CPC G06N 20/00

(57) ABSTRACT

Provided are methods for multi-task learning (MTL) in deep neural networks. An exemplary method may include receiving an MTL model; receiving a testing data set comprising testing data items for the MTL model, each testing data item comprising a plurality of elements, each element associated with a respective feature; grouping the features into a plurality of groups based on an impact of each feature on the tasks of the MTL model, determining an overall accuracy score and task-specific accuracy scores based on inputting the testing data to the MTL model; applying feature reduction evaluation (FRE) to provide a feature score for each feature; and adjusting the feature scores based on a respective grouping associated with the respective feature and at least one of the overall accuracy score, the task-specific accuracy scores, or any combination thereof to provide an adjusted feature score. Systems and computer program products are also disclosed.

### CROSS-REFERENCE TO RELATED APPLICATION

The present application claims the benefit of U.S. Provisional Patent Application No. 63/144,164 filed Feb. 1, 2021, the disclosure of which is hereby incorporated by reference in its entirety.

### BACKGROUND

### 1. Field

This disclosed subject matter relates generally to methods, systems, and products for multi-task learning in deep neural networks and, in some particular embodiments or aspects, to methods, systems, and computer program products for feature selection for and/or uses of multi-task learning in deep neural networks.

### 2. Technical Considerations

Certain systems may use multi-task learning (MTL) models. For example, a deep neural network (DNN) may include a plurality of layers including an input layer, at least one hidden layer (e.g., a plurality of hidden layers and/or the like), and at least one output layer. For MTL, at least some of the hidden layer(s) (and/or the input layer) of the DNN model may be shared between multiple tasks, and each task may have associated therewith at least one output layer (e.g., separate from the output layer(s) of other tasks). For example, sharing layers (e.g., hidden layers, input layer, and/or the like) may include hard parameter sharing (HPS) and/or the like.

However, selecting features (e.g., features to be input into the input layer and/or the like) for MTL models may be difficult. For example, as MTL involves multiple tasks (e.g., predictions and/or the like) being performed by one model, it is challenging to evaluate the features (e.g., the importance of the features, the performance of the model based on the features, the impact of the features, and/or the like) because different features may have different impact (e.g., relevance, predictive power, and/or the like) for different tasks. Moreover, there is no standard (e.g., accepted, widely used, and/or the like) technique for feature selection for MTL (e.g., for DNN MTL models and/or the like). For example, techniques that are highly theoretical and/or difficult to interpret may be inadequate. Additionally or alternatively, techniques that are based on adjustments in a loss function (e.g., of the model and/or the like) may be dependent on the type of model, the type of loss function, and/or the like and, therefore, may result in bias and/or otherwise be inadequate (e.g., for other types of models, other types of loss functions, and/or the like).

Certain determinations may be based on multiple pieces of information that may be received at different times. For example, a payment transaction may be a dual-message transaction, in which at least one first message (e.g., authorization request, authorization response, and/or the like) is communicated at the time of the payment transaction, and at least one second message (e.g., clearing message, settlement message, and/or the like) is communicated at a later point in time (e.g., at the end of the day, one day layer, multiple days later, and/or the like). Certain systems (e.g., issuer systems and/or the like) may treat the time between the first message(s) and the second message(s) differently. For example, an issuer system may place an alert on an account based on the first message(s), may put a hold on an account based on the first message(s), may associate a pending transaction with an account based on the first message(s), etc. Further, such issuer systems may not post a transaction to an account until after the second message(s) is communicated. As such, there may be consumer confusion and/or frustration, inaccuracies (e.g., inaccurate determinations of available funds and/or the like), reduced transparency, delays, inconsistencies, and/or the like associated with such issuers and/or issuer systems.

### SUMMARY

Accordingly, it is an object of the presently disclosed subject matter to provide methods, systems, and computer program products for multi-task learning in deep neural networks that overcome some or all of the deficiencies identified above.

According to some non-limiting embodiments or aspects, provided is a computer-implemented method, comprising: receiving, with at least one processor, a first multi-task learning model associated with a first task and at least one second task; receiving, with the at least one processor, a testing data set comprising a plurality of testing data items for the first multi-task learning model, each testing data item comprising a plurality of elements, each element of the plurality of elements associated with a respective feature of a plurality of features; grouping, with the at least one processor, the plurality of features into a plurality of groups based on an impact of each feature of the plurality of features on the first task and the at least one second task; determining, with the at least one processor, an overall accuracy score, a first task accuracy score, and at least one second task accuracy score based on inputting the testing data set to the first multi-task learning model; applying, with the at least one processor, feature reduction evaluation (FRE) based on the first multi-task learning model and the testing data set to provide a feature score for each feature of the plurality of features; and adjusting, with the at least one processor, the feature score of each respective feature of the plurality of features based on a respective grouping of the plurality of groupings associated with the respective feature and at least one of the overall accuracy score, the first task accuracy score, the at least one second task accuracy score, or a combination thereof to provide an adjusted feature score for the respective feature.

In some non-limiting embodiments or aspects, the computer-implemented method further includes: selecting, with the at least one processor, a subset of the plurality of features based on the adjusted feature score for each respective feature of the plurality of features.

In some non-limiting embodiments or aspects, the computer-implemented method further includes: training, with the at least one processor, a second multi-task learning model based on the subset of the plurality of features.

In some non-limiting embodiments or aspects, the computer-implemented method further includes: communicating, with the at least one processor, the adjusted feature score for each respective feature of the plurality of features to a remote computing device.

In some non-limiting embodiments or aspects, the computer-implemented method further includes: grouping the plurality of features into a plurality of groups comprising: training, with the at least one processor, a second multi-task learning model based on a subset of the testing data set; applying, with the at least one processor, FRE based on the second multi-task learning model and the subset of the testing data set to provide a first impact score for each feature of the plurality of features on the first task and at least one second impact score for each feature of the plurality of features on the at least one second task; and grouping, with the at least one processor, the plurality of features into the plurality of groups based on the first impact score and the at least one second impact score.

In some non-limiting embodiments or aspects, the computer-implemented method further includes: the second multi-task learning model comprising an input layer, a first plurality of hidden layers associated with the first task, an output layer associated with the first task, at least one second plurality of hidden layers associated with the at least one second task, and at least one output layer associated with the at least one second task.

In some non-limiting embodiments or aspects, the computer-implemented method further includes: grouping the plurality of features into the plurality of groups based on the first impact score and the at least one second impact score comprising: ranking, with the at least one processor, the plurality of features based on the first impact score of each feature of the plurality of features to provide a first ranking of the plurality of features; determining, with the at least one processor, a first subset of features based on a first top portion of the first ranking of the plurality of features; determining, with the at least one processor, a second subset of features comprising features of the plurality of features not in the first subset of features; ranking, with the at least one processor, the plurality of features based on the at least one second impact score of each feature of the plurality of features to provide at least one second ranking of the plurality of features; determining, with the at least one processor, at least one third subset of features based on at least one second top portion of the at least one second ranking of the plurality of features; determining, with the at least one processor, at least one fourth subset of features comprising features of the plurality of features not in the at least one third subset of features; and grouping, with the at least one processor, the plurality of features based on the first subset of features, the second subset of features, the at least one third subset of features, and the at least one fourth subset of features.

In some non-limiting embodiments or aspects, the computer-implemented method further includes: grouping the plurality of features based on the first subset of features, the second subset of features, the at least one third subset of features, and the at least one fourth subset of features comprising: determining, with the at least one processor, a first group of the plurality of features based on the first subset and the at least one third subset; determining, with the at least one processor, a second group of the plurality of features based on the first subset and the at least one fourth subset; determining, with the at least one processor, a third group of the plurality of features based on the second subset and the at least one third subset; and determining, with the at least one processor, a fourth group of the plurality of features based on the second subset and the at least one fourth subset.

In some non-limiting embodiments or aspects, the computer-implemented method further includes: adjusting the feature score of each respective feature of the plurality of features comprising: adjusting, with the at least one processor, the feature score of each respective feature of the first group of the plurality of features based on the overall accuracy score to provide the adjusted feature score for the respective feature of the first group of the plurality of features; adjusting, with the at least one processor, the feature score of each respective feature of the second group of the plurality of features based on the overall accuracy score and the at least one second task accuracy score to provide the adjusted feature score for the respective feature of the second group of the plurality of features; adjusting, with the at least one processor, the feature score of each respective feature of the third group of the plurality of features based on the overall accuracy score and the first task accuracy score to provide the adjusted feature score for the respective feature of the third group of the plurality of features; and adjusting, with the at least one processor, the feature score of each respective feature of the fourth group of the plurality of features based on the overall accuracy score, the first task accuracy score, and the at least one second task accuracy score to provide the adjusted feature score for the respective feature of the fourth group of the plurality of features.

In some non-limiting embodiments or aspects, the computer-implemented method further includes: the first task comprising generating, based on an authorization request, a first prediction associated with a likelihood of a first transaction amount in the authorization request matching a second transaction amount in at least one clearing message corresponding to the authorization request.

In some non-limiting embodiments or aspects, the computer-implemented method further includes: the at least one second task comprising at least one of generating, based on the authorization request, a second prediction associated with when the at least one clearing message will be received after the authorization message, generating, based on the authorization request, a third prediction associated with a number of clearing messages of the at least one clearing message, or any combination thereof.

In some non-limiting embodiments or aspects, the computer-implemented method further includes: the first prediction comprising a first score.

In some non-limiting embodiments or aspects, the computer-implemented method further includes: receiving, with the at least one processor, the authorization request from at least one of a merchant system or an acquirer system; generating, with the at least one processor, based on the authorization request, the first score associated with the likelihood of the first transaction amount in the authorization request matching the second transaction amount in the at least one clearing message corresponding to the authorization request; inserting, with the at least one processor, the first score into at least one field of the authorization request to provide an enhanced authorization request; and communicating, with the at least one processor, the enhanced authorization request to an issuer system.

In some non-limiting embodiments or aspects, the computer-implemented method further includes: generating the first score comprises: determining, with the at least one processor, a first plurality of elements based on the authorization request, each element of the first plurality of elements associated with a first respective feature of the plurality of features; and inputting, with the at least one processor, the first plurality of elements to the first multi-task learning model to generate the first score associated with the likelihood of the first transaction amount in the authorization request matching the second transaction amount in the at least one clearing message corresponding to the authorization request.

In some non-limiting embodiments or aspects, the computer-implemented method further includes: determining, with the at least one processor, based on the authorization request, that the issuer system is enrolled in a program before generating the first score.

In some non-limiting embodiments or aspects, the computer-implemented method further includes: generating the first score, inserting the first score into the at least one field of the authorization request to provide the enhanced authorization request, and communicating the enhanced authorization request are in response to determining that the issuer is enrolled in the program.

In some non-limiting embodiments or aspects, the computer-implemented method further includes: the issuer system determining to post a transaction associated with the authorization request to an account before receiving the clearing message corresponding to the authorization request based on the first score in the enhanced authorization request satisfying a threshold.

According to some non-limiting embodiments or aspects, provided is a computer-implemented method, comprising: receiving, with at least one processor, an authorization request from at least one of a merchant system or an acquirer system; generating, with the at least one processor, based on the authorization request and a machine learning model, a first score associated with a likelihood of a first transaction amount in the authorization request matching a second transaction amount in at least one clearing message corresponding to the authorization request; inserting, with the at least one processor, the first score into at least one field of the authorization request to provide an enhanced authorization request; and communicating, with the at least one processor, the enhanced authorization request to an issuer system.

In some non-limiting embodiments or aspects, the computer-implemented method further includes: the machine learning model comprising at least one of a deep neural network (DNN), a multi-task learning model, or any combination thereof.

According to some non-limiting embodiments or aspects, provided is a system, comprising: at least one processor; and at least one non-transitory computer-readable medium including one or more instructions that, when executed by the at least one processor, direct the at least one processor to: receive a first multi-task learning model associated with a first task and at least one second task; receive a testing data set comprising a plurality of testing data items for the first multi-task learning model, each testing data item comprising a plurality of elements, each element of the plurality of elements associated with a respective feature of a plurality of features; group the plurality of features into a plurality of groups based on an impact of each feature of the plurality of features on the first task and the at least one second task; determine an overall accuracy score, a first task accuracy score, and at least one second task accuracy score based on inputting the testing data set to the first multi-task learning model; apply feature reduction evaluation (FRE) based on the first multi-task learning model and the testing data set to provide a feature score for each feature of the plurality of features; and adjust the feature score of each respective feature of the plurality of features based on a respective grouping of the plurality of groupings associated with the respective feature and at least one of the overall accuracy score, the first task accuracy score, the at least one second task accuracy score, or a combination thereof to provide an adjusted feature score for the respective feature.

Other non-limiting embodiments or aspects will be set forth in the following numbered clauses:

Clause 1: A computer-implemented method, comprising: receiving, with at least one processor, a first multi-task learning model associated with a first task and at least one second task; receiving, with the at least one processor, a testing data set comprising a plurality of testing data items for the first multi-task learning model, each testing data item comprising a plurality of elements, each element of the plurality of elements associated with a respective feature of a plurality of features; grouping, with the at least one processor, the plurality of features into a plurality of groups based on an impact of each feature of the plurality of features on the first task and the at least one second task; determining, with the at least one processor, an overall accuracy score, a first task accuracy score, and at least one second task accuracy score based on inputting the testing data set to the first multi-task learning model; applying, with the at least one processor, feature reduction evaluation (FRE) based on the first multi-task learning model and the testing data set to provide a feature score for each feature of the plurality of features; and adjusting, with the at least one processor, the feature score of each respective feature of the plurality of features based on a respective grouping of the plurality of groupings associated with the respective feature and at least one of the overall accuracy score, the first task accuracy score, the at least one second task accuracy score, or a combination thereof to provide an adjusted feature score for the respective feature.

Clause 2: The computer-implemented method of clause 1, further comprising selecting, with the at least one processor, a subset of the plurality of features based on the adjusted feature score for each respective feature of the plurality of features.

Clause 3: The computer-implemented method of clauses 1 or 2, further comprising training, with the at least one processor, a second multi-task learning model based on the subset of the plurality of features.

Clause 4: The computer-implemented method of any of clauses 1-3, further comprising communicating, with the at least one processor, the adjusted feature score for each respective feature of the plurality of features to a remote computing device.

Clause 5: The computer-implemented method of any of clauses 1-4, wherein grouping the plurality of features into a plurality of groups comprises: training, with the at least one processor, a second multi-task learning model based on a subset of the testing data set; applying, with the at least one processor, FRE based on the second multi-task learning model and the subset of the testing data set to provide a first impact score for each feature of the plurality of features on the first task and at least one second impact score for each feature of the plurality of features on the at least one second task; and grouping, with the at least one processor, the plurality of features into the plurality of groups based on the first impact score and the at least one second impact score.

Clause 6: The computer-implemented method of any of clauses 1-5, wherein the second multi-task learning model comprises an input layer, a first plurality of hidden layers associated with the first task, an output layer associated with the first task, at least one second plurality of hidden layers associated with the at least one second task, and at least one output layer associated with the at least one second task.

Clause 7: The computer-implemented method of any of clauses 1-6, wherein grouping the plurality of features into the plurality of groups based on the first impact score and the at least one second impact score comprises: ranking, with the at least one processor, the plurality of features based on the first impact score of each feature of the plurality of features to provide a first ranking of the plurality of features; determining, with the at least one processor, a first subset of features based on a first top portion of the first ranking of the plurality of features; determining, with the at least one processor, a second subset of features comprising features of the plurality of features not in the first subset of features; ranking, with the at least one processor, the plurality of features based on the at least one second impact score of each feature of the plurality of features to provide at least one second ranking of the plurality of features; determining, with the at least one processor, at least one third subset of features based on at least one second top portion of the at least one second ranking of the plurality of features; determining, with the at least one processor, at least one fourth subset of features comprising features of the plurality of features not in the at least one third subset of features; and grouping, with the at least one processor, the plurality of features based on the first subset of features, the second subset of features, the at least one third subset of features, and the at least one fourth subset of features.

Clause 8: The computer-implemented method of any of clauses 1-7, wherein grouping the plurality of features based on the first subset of features, the second subset of features, the at least one third subset of features, and the at least one fourth subset of features comprises: determining, with the at least one processor, a first group of the plurality of features based on the first subset and the at least one third subset; determining, with the at least one processor, a second group of the plurality of features based on the first subset and the at least one fourth subset; determining, with the at least one processor, a third group of the plurality of features based on the second subset and the at least one third subset; and determining, with the at least one processor, a fourth group of the plurality of features based on the second subset and the at least one fourth subset.

Clause 9: The computer-implemented method of any of clauses 1-8, wherein adjusting the feature score of each respective feature of the plurality of features comprises: adjusting, with the at least one processor, the feature score of each respective feature of the first group of the plurality of features based on the overall accuracy score to provide the adjusted feature score for the respective feature of the first group of the plurality of features; adjusting, with the at least one processor, the feature score of each respective feature of the second group of the plurality of features based on the overall accuracy score and the at least one second task accuracy score to provide the adjusted feature score for the respective feature of the second group of the plurality of features; adjusting, with the at least one processor, the feature score of each respective feature of the third group of the plurality of features based on the overall accuracy score and the first task accuracy score to provide the adjusted feature score for the respective feature of the third group of the plurality of features; and adjusting, with the at least one processor, the feature score of each respective feature of the fourth group of the plurality of features based on the overall accuracy score, the first task accuracy score, and the at least one second task accuracy score to provide the adjusted feature score for the respective feature of the fourth group of the plurality of features.

Clause 10: The computer-implemented method of any of clauses 1-9, wherein the first task comprises generating, based on an authorization request, a first prediction associated with a likelihood of a first transaction amount in the authorization request matching a second transaction amount in at least one clearing message corresponding to the authorization request.

Clause 11: The computer-implemented method of any of clauses 1-10, wherein the at least one second task comprises at least one of generating, based on the authorization request, a second prediction associated with when the at least one clearing message will be received after the authorization message, generating, based on the authorization request, a third prediction associated with a number of clearing messages of the at least one clearing message, or any combination thereof.

Clause 12: The computer-implemented method of any of clauses 1-11, wherein the first prediction comprises a first score.

Clause 13: The computer-implemented method of any of clauses 1-12, further comprising: receiving, with the at least one processor, the authorization request from at least one of a merchant system or an acquirer system; generating, with the at least one processor, based on the authorization request, the first score associated with the likelihood of the first transaction amount in the authorization request matching the second transaction amount in the at least one clearing message corresponding to the authorization request; inserting, with the at least one processor, the first score into at least one field of the authorization request to provide an enhanced authorization request; and communicating, with the at least one processor, the enhanced authorization request to an issuer system.

Clause 14: The computer-implemented method of any of clauses 1-13, wherein generating the first score comprises: determining, with the at least one processor, a first plurality of elements based on the authorization request, each element of the first plurality of elements associated with a first respective feature of the plurality of features; and inputting, with the at least one processor, the first plurality of elements to the first multi-task learning model to generate the first score associated with the likelihood of the first transaction amount in the authorization request matching the second transaction amount in the at least one clearing message corresponding to the authorization request.

Clause 15: The computer-implemented method of any of clauses 1-14, further comprising determining, with the at least one processor, based on the authorization request, that the issuer system is enrolled in a program before generating the first score.

Clause 16: The computer-implemented method of any of clauses 1-15, wherein generating the first score, inserting the first score into the at least one field of the authorization request to provide the enhanced authorization request, and communicating the enhanced authorization request are in response to determining that the issuer is enrolled in the program.

Clause 17: The computer-implemented method of any of clauses 1-16, wherein the issuer system determines to post a transaction associated with the authorization request to an account before receiving the clearing message corresponding to the authorization request based on the first score in the enhanced authorization request satisfying a threshold.

Clause 18: A computer-implemented method, comprising: receiving, with at least one processor, an authorization request from at least one of a merchant system or an acquirer system; generating, with the at least one processor, based on the authorization request and a machine learning model, a first score associated with a likelihood of a first transaction amount in the authorization request matching a second transaction amount in at least one clearing message corresponding to the authorization request; inserting, with the at least one processor, the first score into at least one field of the authorization request to provide an enhanced authorization request; and communicating, with the at least one processor, the enhanced authorization request to an issuer system.

Clause 19: The computer-implemented method of clause 18, wherein the machine learning model comprises at least one of a deep neural network (DNN), a multi-task learning model, or any combination thereof.

Clause 20: A system, comprising: at least one processor; and at least one non-transitory computer-readable medium including one or more instructions that, when executed by the at least one processor, direct the at least one processor to: receive a first multi-task learning model associated with a first task and at least one second task; receive a testing data set comprising a plurality of testing data items for the first multi-task learning model, each testing data item comprising a plurality of elements, each element of the plurality of elements associated with a respective feature of a plurality of features; group the plurality of features into a plurality of groups based on an impact of each feature of the plurality of features on the first task and the at least one second task; determine an overall accuracy score, a first task accuracy score, and at least one second task accuracy score based on inputting the testing data set to the first multi-task learning model; apply feature reduction evaluation (FRE) based on the first multi-task learning model and the testing data set to provide a feature score for each feature of the plurality of features; and adjust the feature score of each respective feature of the plurality of features based on a respective grouping of the plurality of groupings associated with the respective feature and at least one of the overall accuracy score, the first task accuracy score, the at least one second task accuracy score, or a combination thereof to provide an adjusted feature score for the respective feature.

These and other features and characteristics of the presently disclosed subject matter, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter. As used in the specification and the claims, the singular form of “a,” “an,” and “the” include plural referents unless the context clearly dictates otherwise.

### BRIEF DESCRIPTION OF THE DRAWINGS

Additional advantages and details of the disclosed subject matter are explained in greater detail below with reference to the exemplary embodiments or aspects that are illustrated in the accompanying figures, in which:

FIG. 1 is a diagram of a non-limiting embodiment or aspect of an environment in which methods, systems, and/or computer program products, described herein, may be implemented according to the principles of the presently disclosed subject matter;

FIG. 2 is a diagram of a non-limiting embodiment or aspect of components of one or more devices of FIG. 1;

FIG. 3 is a flowchart of a non-limiting embodiment of a process for multi-task learning in deep neural networks according to the principles of the presently disclosed subject matter;

FIG. 4 is a flowchart of a non-limiting embodiment of a process for enhancing an authorization request using multi-task learning in deep neural networks according to the principles of the presently disclosed subject matter;

FIG. 5 is a diagram of a non-limiting embodiment of an implementation of a non-limiting embodiment of the process shown in FIG. 3 and/or FIG. 4, according to the principles of the presently disclosed subject matter;

FIG. 6 is a diagram of a non-limiting embodiment of an implementation of a non-limiting embodiment of the process shown in FIG. 3 and/or FIG. 4, according to the principles of the presently disclosed subject matter; and

FIG. 7 is a diagram of a non-limiting embodiment of an implementation of a non-limiting embodiment of the process shown in FIG. 3 and/or FIG. 4, according to the principles of the presently disclosed subject matter.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosed subject matter as it is oriented in the drawing figures. However, it is to be understood that the disclosed subject matter may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the terms “issuer institution,” “portable financial device issuer,” “issuer,” or “issuer bank” may refer to one or more entities that provide accounts to customers for conducting transactions (e.g., payment transactions), such as initiating credit and/or debit payments. For example, an issuer institution may provide an account identifier, such as a primary account number (PAN), to a customer that uniquely identifies one or more accounts associated with that customer. The account identifier may be embodied on a portable financial device, such as a physical financial instrument, e.g., a payment card, and/or may be electronic and used for electronic payments. The terms “issuer institution” and “issuer institution system” may also refer to one or more computer systems operated by or on behalf of an issuer institution, such as a server computer executing one or more software applications. For example, an issuer institution system may include one or more authorization servers for authorizing a transaction.

As used herein, the term “account identifier” may include one or more types of identifiers associated with a user account (e.g., a PAN, a card number, a payment card number, a payment token, and/or the like). In some non-limiting embodiments or aspects, an issuer institution may provide an account identifier (e.g., a PAN, a payment token, and/or the like) to a user that uniquely identifies one or more accounts associated with that user. The account identifier may be embodied on a physical financial instrument (e.g., a portable financial instrument, a payment card, a credit card, a debit card, and/or the like) and/or may be electronic information communicated to the user that the user may use for electronic payments. In some non-limiting embodiments or aspects, the account identifier may be an original account identifier, where the original account identifier was provided to a user at the creation of the account associated with the account identifier. In some non-limiting embodiments or aspects, the account identifier may be an account identifier (e.g., a supplemental account identifier) that is provided to a user after the original account identifier was provided to the user. For example, if the original account identifier is forgotten, stolen, and/or the like, a supplemental account identifier may be provided to the user. In some non-limiting embodiments or aspects, an account identifier may be directly or indirectly associated with an issuer institution such that an account identifier may be a payment token that maps to a PAN or other type of identifier. Account identifiers may be alphanumeric, any combination of characters and/or symbols, and/or the like. An issuer institution may be associated with a bank identification number (BIN) that uniquely identifies the issuer institution.

As used herein, the terms “payment token” or “token” may refer to an identifier that is used as a substitute or replacement identifier for an account identifier, such as a PAN. Tokens may be associated with a PAN or other account identifiers in one or more data structures (e.g., one or more databases and/or the like) such that they can be used to conduct a transaction (e.g., a payment transaction) without directly using the account identifier, such as a PAN. In some examples, an account identifier, such as a PAN, may be associated with a plurality of tokens for different individuals, different uses, and/or different purposes. For example, a payment token may include a series of numeric and/or alphanumeric characters that may be used as a substitute for an original account identifier. For example, a payment token “4900 0000 0000 0001” may be used in place of a PAN “4147 0900 0000 1234.” In some non-limiting embodiments or aspects, a payment token may be “format preserving” and may have a numeric format that conforms to the account identifiers used in existing payment processing networks (e.g., ISO 8583 financial transaction message format). In some non-limiting embodiments or aspects, a payment token may be used in place of a PAN to initiate, authorize, settle, or resolve a payment transaction or represent the original credential in other systems where the original credential would typically be provided. In some non-limiting embodiments or aspects, a token value may be generated such that the recovery of the original PAN or other account identifier from the token value may not be computationally derived (e.g., with a one-way hash or other cryptographic function). Further, in some non-limiting embodiments or aspects, the token format may be configured to allow the entity receiving the payment token to identify it as a payment token and recognize the entity that issued the token.

As used herein, the term “provisioning” may refer to a process of enabling a device to use a resource or service. For example, provisioning may involve enabling a device to perform transactions using an account. Additionally or alternatively, provisioning may include adding provisioning data associated with account data (e.g., a payment token representing an account number) to a device.

As used herein, the term “token requestor” may refer to an entity that is seeking to implement tokenization according to embodiments or aspects of the presently disclosed subject matter. For example, the token requestor may initiate a request that a PAN be tokenized by submitting a token request message to a token service provider. Additionally or alternatively, a token requestor may no longer need to store a PAN associated with a token once the requestor has received the payment token in response to a token request message. In some non-limiting embodiments or aspects, the requestor may be an application, a device, a process, or a system that is configured to perform actions associated with tokens. For example, a requestor may request registration with a network token system, request token generation, token activation, token de-activation, token exchange, other token lifecycle management related processes, and/or any other token related processes. In some non-limiting embodiments or aspects, a requestor may interface with a network token system through any suitable communication network and/or protocol (e.g., using HTTPS, SOAP, and/or an XML interface among others). For example, a token requestor may include card-on-file merchants, acquirers, acquirer processors, payment gateways acting on behalf of merchants, payment enablers (e.g., original equipment manufacturers, mobile network operators, and/or the like), digital wallet providers, issuers, third-party wallet providers, payment processing networks, and/or the like. In some non-limiting embodiments or aspects, a token requestor may request tokens for multiple domains and/or channels. Additionally or alternatively, a token requestor may be registered and identified uniquely by the token service provider within the tokenization ecosystem. For example, during token requestor registration, the token service provider may formally process a token requestor's application to participate in the token service system. In some non-limiting embodiments or aspects, the token service provider may collect information pertaining to the nature of the requestor and relevant use of tokens to validate and formally approve the token requestor and establish appropriate domain restriction controls. Additionally or alternatively, successfully registered token requestors may be assigned a token requestor identifier that may also be entered and maintained within the token vault. In some non-limiting embodiments or aspects, token requestor identifiers may be revoked and/or token requestors may be assigned new token requestor identifiers. In some non-limiting embodiments or aspects, this information may be subject to reporting and audit by the token service provider.

As used herein, the term a “token service provider” may refer to an entity including one or more server computers in a token service system that generates, processes and maintains payment tokens. For example, the token service provider may include or be in communication with a token vault where the generated tokens are stored. Additionally or alternatively, the token vault may maintain one-to-one mapping between a token and a PAN represented by the token. In some non-limiting embodiments or aspects, the token service provider may have the ability to set aside licensed BINs as token BINs to issue tokens for the PANs that may be submitted to the token service provider. In some non-limiting embodiments or aspects, various entities of a tokenization ecosystem may assume the roles of the token service provider. For example, payment networks and issuers or their agents may become the token service provider by implementing the token services according to non-limiting embodiments or aspects of the presently disclosed subject matter. Additionally or alternatively, a token service provider may provide reports or data output to reporting tools regarding approved, pending, or declined token requests, including any assigned token requestor ID. The token service provider may provide data output related to token-based transactions to reporting tools and applications and present the token and/or PAN as appropriate in the reporting output. In some non-limiting embodiments or aspects, the EMVCo standards organization may publish specifications defining how tokenized systems may operate. For example, such specifications may be informative, but they are not intended to be limiting upon any of the presently disclosed subject matter.

As used herein, the term “token vault” may refer to a repository that maintains established token-to-PAN mappings. For example, the token vault may also maintain other attributes of the token requestor that may be determined at the time of registration and/or that may be used by the token service provider to apply domain restrictions or other controls during transaction processing. In some non-limiting embodiments or aspects, the token vault may be a part of a token service system. For example, the token vault may be provided as a part of the token service provider. Additionally or alternatively, the token vault may be a remote repository accessible by the token service provider. In some non-limiting embodiments or aspects, token vaults, due to the sensitive nature of the data mappings that are stored and managed therein, may be protected by strong underlying physical and logical security. Additionally or alternatively, a token vault may be operated by any suitable entity, including a payment network, an issuer, clearing houses, other financial institutions, transaction service providers, and/or the like.

As used herein, the term “merchant” may refer to one or more entities (e.g., operators of retail businesses that provide goods and/or services, and/or access to goods and/or services, to a user (e.g., a customer, a consumer, a customer of the merchant, and/or the like) based on a transaction (e.g., a payment transaction)). As used herein, the term “merchant system” may refer to one or more computer systems operated by or on behalf of a merchant, such as a server computer executing one or more software applications. As used herein, the term “product” may refer to one or more goods and/or services offered by a merchant.

As used herein, the term “point-of-sale (POS) device” may refer to one or more devices, which may be used by a merchant to initiate transactions (e.g., a payment transaction), engage in transactions, and/or process transactions. For example, a POS device may include one or more computers, peripheral devices, card readers, near-field communication (NFC) receivers, radio frequency identification (RFID) receivers, and/or other contactless transceivers or receivers, contact-based receivers, payment terminals, computers, servers, input devices, and/or the like.

As used herein, the term “point-of-sale (POS) system” may refer to one or more computers and/or peripheral devices used by a merchant to conduct a transaction. For example, a POS system may include one or more POS devices and/or other like devices that may be used to conduct a payment transaction. A POS system (e.g., a merchant POS system) may also include one or more server computers programmed or configured to process online payment transactions through webpages, mobile applications, and/or the like.

As used herein, the term “transaction service provider” may refer to an entity that receives transaction authorization requests from merchants or other entities and provides guarantees of payment, in some cases through an agreement between the transaction service provider and the issuer institution. In some non-limiting embodiments or aspects, a transaction service provider may include a credit card company, a debit card company, and/or the like. As used herein, the term “transaction service provider system” may also refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

As used herein, the term “acquirer” may refer to an entity licensed by the transaction service provider and approved by the transaction service provider to originate transactions (e.g., payment transactions) using a portable financial device associated with the transaction service provider. As used herein, the term “acquirer system” may also refer to one or more computer systems, computer devices, and/or the like operated by or on behalf of an acquirer. The transactions may include payment transactions (e.g., purchases, original credit transactions (OCTs), account funding transactions (AFTs), and/or the like). In some non-limiting embodiments or aspects, the acquirer may be authorized by the transaction service provider to assign merchant or service providers to originate transactions using a portable financial device of the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure that proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by an acquirer's payment facilitators, and/or the like. In some non-limiting embodiments or aspects, an acquirer may be a financial institution, such as a bank.

As used herein, the terms “electronic wallet,” “electronic wallet mobile application,” and “digital wallet” may refer to one or more electronic devices and/or one or more software applications configured to initiate and/or conduct transactions (e.g., payment transactions, electronic payment transactions, and/or the like). For example, an electronic wallet may include a user device (e.g., a mobile device) executing an application program and server-side software and/or databases for maintaining and providing transaction data to the user device. As used herein, the term “electronic wallet provider” may include an entity that provides and/or maintains an electronic wallet and/or an electronic wallet mobile application for a user (e.g., a customer). Examples of an electronic wallet provider include, but are not limited to, Google Pay®, Android Pay®, Apple Pay®, and Samsung Pay®. In some non-limiting examples, a financial institution (e.g., an issuer institution) may be an electronic wallet provider. As used herein, the term “electronic wallet provider system” may refer to one or more computer systems, computer devices, servers, groups of servers, and/or the like operated by or on behalf of an electronic wallet provider.

As used herein, the term “portable financial device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a cellular phone, an electronic wallet mobile application, a personal digital assistant (PDA), a pager, a security card, a computer, an access card, a wireless terminal, a transponder, and/or the like. In some non-limiting embodiments or aspects, the portable financial device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway and/or to a payment gateway itself. As used herein, the term “payment gateway mobile application” may refer to one or more electronic devices and/or one or more software applications configured to provide payment services for transactions (e.g., payment transactions, electronic payment transactions, and/or the like).

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more POS devices used by a merchant, one or more acquirer host computers used by an acquirer, one or more mobile devices used by a user, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “computing device” may refer to one or more electronic devices that are configured to directly or indirectly communicate with or over one or more networks. A computing device may be a mobile device, a desktop computer, and/or any other like device. Furthermore, the term “computer” may refer to any computing device that includes the necessary components to receive, process, and output data, and normally includes a display, a processor, a memory, an input device, and a network interface. As used herein, the term “server” may refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, such as POS devices, directly or indirectly communicating in the network environment may constitute a “system,” such as a merchant's POS system.

The term “processor,” as used herein, may represent any type of processing unit, such as a single processor having one or more cores, one or more cores of one or more processors, multiple processors each having one or more cores, and/or other arrangements and combinations of processing units.

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

Non-limiting embodiments or aspects of the disclosed subject matter are directed to methods, systems, and computer program products for multi-task learning in deep neural networks, including, but not limited to, feature selection therefor and uses thereof. For example, non-limiting embodiments or aspects of the disclosed subject matter provide receiving an MTL model; receiving a testing data set comprising testing data items for the MTL model, each testing data item comprising a plurality of elements, each element associated with a respective feature; grouping the features into a plurality of groups based on an impact of each feature on the tasks of the MTL model, determining an overall accuracy score and task-specific accuracy scores based on inputting the testing data to the MTL model; applying feature reduction evaluation (FRE) to provide a feature score for each feature; and adjusting each feature score based on a respective grouping associated with the respective feature and at least one of the overall accuracy score, the task-specific accuracy scores, or any combination thereof to provide an adjusted feature score. Such embodiments provide techniques and systems that enable automatic feature evaluation and/or selection. For example, such automatic feature evaluation and/or selection may be performed simply based on a model (e.g., MTL model) and a testing dataset. Additionally or alternatively, such embodiments provide generalized and/or scalable techniques and systems with reduced (e.g., eliminated, decreased, and/or the like) bias on a model structure (e.g., DNN model structure and/or the like) and/or that can be applied to any type of MTL model (e.g., MTL models with relatively large numbers of tasks and/or the like). Additionally or alternatively, such embodiments provide techniques and systems that enable automatic evaluation and/or selection of features not only based on the impact of each feature on the performance of the MTL model, but also based on the impact of each feature on the performance of each individual task. Additionally or alternatively, such embodiments provide techniques and systems that enable evaluation and/or selection of features without a need to know the name and/or description of each feature (e.g., in the testing data set), and therefore, confidentiality and/or security can be preserved. Additionally or alternatively, such embodiments provide techniques and systems that enable evaluation and/or selection of features that are easily interpretable. Additionally or alternatively, such embodiments provide techniques and systems that allow for making determinations based on the output(s) of a model (e.g., the output/prediction of each task of an MTL model) when certain information typically relied upon by such determinations is unavailable (e.g., not yet received and/or the like). For example, based on the output(s) of such a model, an issuer system may determine whether to post a transaction to an account after receiving a first message (e.g., an authorization request) but before receiving a second message (e.g., a clearing message) for a payment transaction (e.g., a dual-message transaction). For example, if the issuer system has a sufficiently high degree of certainty (e.g., at least one output (e.g., score) of a model (e.g., DNN model, MTL model, and/or the like) satisfying a threshold and/or the like) that a transaction can be posted early (e.g., at the time of receiving the authorization request, before receiving the clearing message, and/or the like), posting the transaction may improve the consumer's experience (e.g., reduce confusion, frustration, and/or the like), improve accuracy (of the balance and/or available funds of the consumer's account), improve transparency, reduce (e.g., eliminate, decrease, and/or the like) delays, reduce inconsistencies, and/or the like.

For the purpose of illustration, in the following description, while the presently disclosed subject matter is described with respect to methods, systems, and computer program products for multi-task learning in deep neural networks, e.g., for payment transactions, one skilled in the art will recognize that the disclosed subject matter is not limited to the illustrative embodiments or aspects. For example, the methods, systems, and computer program products described herein may be used with a wide variety of settings, such as multi-task learning in deep neural networks in any setting suitable for using such deep neural networks, e.g., predictions, regressions, classifications, fraud prevention, authorization, authentication, identification, feature selection, and/or the like.

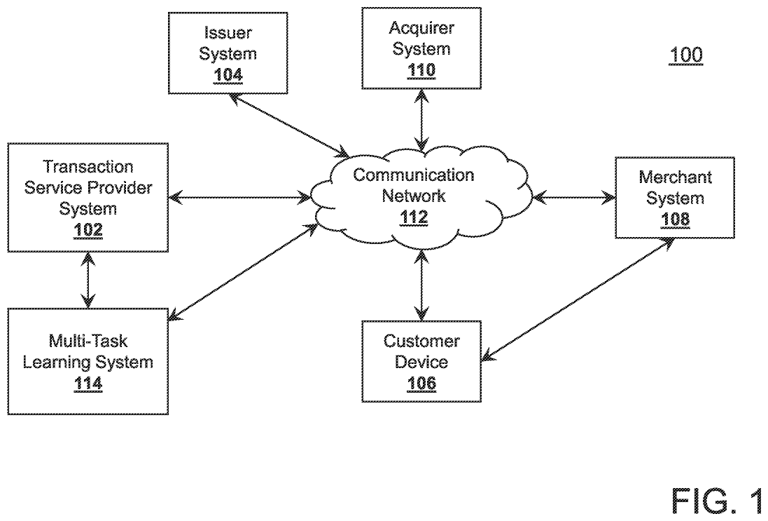

Referring now to FIG. 1, FIG. 1 is a diagram of a non-limiting embodiment or aspect of an environment 100 in which systems, products, and/or methods, as described herein, may be implemented. As shown in FIG. 1, environment 100 includes transaction service provider system 102, issuer system 104, customer device 106, merchant system 108, acquirer system 110, multi-task learning system 114, and communication network 112.

Transaction service provider system 102 may include one or more devices capable of receiving information from and/or communicating information to issuer system 104, customer device 106, merchant system 108, acquirer system 110, and/or multi-task learning system 114 via communication network 112. For example, transaction service provider system 102 may include a computing device, such as a server (e.g., a transaction processing server), a group of servers, and/or other like devices. In some non-limiting embodiments or aspects, transaction service provider system 102 may be associated with a transaction service provider as described herein. In some non-limiting embodiments or aspects, transaction service provider system 102 may be in communication with a data storage device, which may be local or remote to transaction service provider system 102. In some non-limiting embodiments or aspects, transaction service provider system 102 may be capable of receiving information from, storing information in, communicating information to, or searching information stored in the data storage device.

Issuer system 104 may include one or more devices capable of receiving information and/or communicating information to transaction service provider system 102, customer device 106, merchant system 108, acquirer system 110, and/or multi-task learning system 114 via communication network 112. For example, issuer system 104 may include a computing device, such as a server, a group of servers, and/or other like devices. In some non-limiting embodiments or aspects, issuer system 104 may be associated with an issuer institution as described herein. For example, issuer system 104 may be associated with an issuer institution that issued a credit account, debit account, credit card, debit card, and/or the like to a user associated with customer device 106.

Customer device 106 may include one or more devices capable of receiving information from and/or communicating information to transaction service provider system 102, issuer system 104, merchant system 108, acquirer system 110, and/or multi-task learning system 114 via communication network 112. Additionally or alternatively, each customer device 106 may include a device capable of receiving information from and/or communicating information to other customer devices 106 via communication network 112, another network (e.g., an ad hoc network, a local network, a private network, a virtual private network, and/or the like), and/or any other suitable communication technique. For example, customer device 106 may include a client device and/or the like. In some non-limiting embodiments or aspects, customer device 106 may or may not be capable of receiving information (e.g., from merchant system 108 or from another customer device 106) via a short-range wireless communication connection (e.g., an NFC communication connection, an RFID communication connection, a Bluetooth® communication connection, a Zigbee® communication connection, and/or the like), and/or communicating information (e.g., to merchant system 108) via a short-range wireless communication connection.

Merchant system 108 may include one or more devices capable of receiving information from and/or communicating information to transaction service provider system 102, issuer system 104, customer device 106, acquirer system 110, and/or multi-task learning system 114 via communication network 112. Merchant system 108 may also include a device capable of receiving information from customer device 106 via communication network 112, a communication connection (e.g., an NFC communication connection, an RFID communication connection, a Bluetooth® communication connection, a Zigbee® communication connection, and/or the like) with customer device 106, and/or the like, and/or communicating information to customer device 106 via communication network 112, the communication connection, and/or the like. In some non-limiting embodiments or aspects, merchant system 108 may include a computing device, such as a server, a group of servers, a client device, a group of client devices, and/or other like devices. In some non-limiting embodiments or aspects, merchant system 108 may be associated with a merchant as described herein. In some non-limiting embodiments or aspects, merchant system 108 may include one or more client devices. For example, merchant system 108 may include a client device that allows a merchant to communicate information to transaction service provider system 102. In some non-limiting embodiments or aspects, merchant system 108 may include one or more devices, such as computers, computer systems, and/or peripheral devices capable of being used by a merchant to conduct a transaction with a user. For example, merchant system 108 may include a POS device and/or a POS system.

Acquirer system 110 may include one or more devices capable of receiving information from and/or communicating information to transaction service provider system 102, issuer system 104, customer device 106, merchant system 108, and/or multi-task learning system 114 via communication network 112. For example, acquirer system 110 may include a computing device, a server, a group of servers, and/or the like. In some non-limiting embodiments or aspects, acquirer system 110 may be associated with an acquirer as described herein.

Communication network 112 may include one or more wired and/or wireless networks. For example, communication network 112 may include a cellular network (e.g., a long-term evolution (LTE) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

Multi-task learning system 114 may include one or more devices capable of receiving information from and/or communicating information to transaction service provider system 102, issuer system 104, customer device 106, merchant system 108, and/or acquirer system 110 via communication network 112. For example, multi-task learning system 114 may include a computing device, such as a server, a group of servers, and/or other like devices. In some non-limiting embodiments or aspects, multi-task learning system 114 may be the same as, similar to, or a part of transaction service provider system 102. In some non-limiting embodiments or aspects, multi-task learning system 114 may be associated with a transaction service provider as described herein.

In some non-limiting embodiments or aspects, multi-task learning system 114 may include one or more machine learning models. In some non-limiting embodiments or aspects, the one or more machine learning models may include at least one MTL model. The one or more machine learning models may include one or more of a DNN, an MTL model, or any combination thereof. In some non-limiting embodiments or aspects, multi-task learning system 114 may be associated with and/or capable of performing one or more tasks. For example, multi-task learning system 114 may be capable of generating one or more predictions where the one or more predictions are associated with the one or more tasks. In some non-limiting embodiments or aspects, multi-task learning system 114 may receive training data and/or testing data as input to the one or more machine learning models. In some non-limiting embodiments or aspects, multi-task learning system 114 may generate one or more outputs which may be used by multi-task learning system 114 as further inputs. Additionally or alternatively, multi-task learning system 114 may generate one or more outputs which may be communicated to another system of environment 100 (e.g., issuer system 104 and/or the like).

In some non-limiting embodiments or aspects, processing a transaction may include generating and/or communicating at least one transaction message (e.g., authorization request, authorization response, any combination thereof, and/or the like). For example, a client device (e.g., customer device 106, a POS device of merchant system 108, and/or the like) may initiate the transaction, e.g., by generating an authorization request. Additionally or alternatively, the client device (e.g., customer device 106, at least one device of merchant system 108, and/or the like) may communicate the authorization request. For example, customer device 106 may communicate the authorization request to merchant system 108 and/or a payment gateway (e.g., a payment gateway of transaction service provider system 102, a third-party payment gateway separate from transaction service provider system 102, and/or the like). Additionally or alternatively, merchant system 108 (e.g., a POS device thereof) may communicate the authorization request to acquirer system 110 and/or a payment gateway. In some non-limiting embodiments or aspects, acquirer system 110 and/or a payment gateway may communicate the authorization request to transaction service provider system 102 and/or issuer system 104. Additionally or alternatively, transaction service provider system 102 may communicate the authorization request to issuer system 104. In some non-limiting embodiments or aspects, issuer system 104 may determine an authorization decision (e.g., authorize, decline, and/or the like) based on the authorization request. For example, the authorization request may cause issuer system 104 to determine the authorization decision based thereon. In some non-limiting embodiments or aspects, issuer system 104 may generate an authorization response based on the authorization decision. Additionally or alternatively, issuer system 104 may communicate the authorization response. For example, issuer system 104 may communicate the authorization response to transaction service provider system 102 and/or a payment gateway. Additionally or alternatively, transaction service provider system 102 and/or a payment gateway may communicate the authorization response to acquirer system 110, merchant system 108, and/or customer device 106. Additionally or alternatively, acquirer system 110 may communicate the authorization response to merchant system 108 and/or a payment gateway. Additionally or alternatively, a payment gateway may communicate the authorization response to merchant system 108 and/or customer device 106. Additionally or alternatively, merchant system 108 may communicate the authorization response to customer device 106. In some non-limiting embodiments or aspects, merchant system 108 may receive (e.g., from acquirer system 110 and/or a payment gateway) the authorization response. Additionally or alternatively, merchant system 108 may complete the transaction based on the authorization response (e.g., provide, ship, and/or deliver goods and/or services associated with the transaction; fulfill an order associated with the transaction; any combination thereof; and/or the like).

For the purpose of illustration, processing a transaction may include generating a transaction message (e.g., authorization request and/or the like) based on an account identifier of a customer (e.g., associated with customer device 106 and/or the like) and/or transaction data associated with the transaction. For example, merchant system 108 (e.g., a client device of merchant system 108, a POS device of merchant system 108, and/or the like) may initiate the transaction, e.g., by generating an authorization request (e.g., in response to receiving the account identifier from a portable financial device of the customer and/or the like). Additionally or alternatively, merchant system 108 may communicate the authorization request to acquirer system 110. Additionally or alternatively, acquirer system 110 may communicate the authorization request to transaction service provider system 102. Additionally or alternatively, transaction service provider system 102 may communicate the authorization request to issuer system 104. Issuer system 104 may determine an authorization decision (e.g., authorize, decline, and/or the like) based on the authorization request, and/or issuer system 104 may generate an authorization response based on the authorization decision and/or the authorization request. Additionally or alternatively, issuer system 104 may communicate the authorization response to transaction service provider system 102. Additionally or alternatively, transaction service provider system 102 may communicate the authorization response to acquirer system 110, which may communicate the authorization response to merchant system 108.

For the purpose of illustration, clearing and/or settlement of a transaction may include generating a message (e.g., clearing message, settlement message, and/or the like) based on an account identifier of a customer (e.g., associated with customer device 106 and/or the like) and/or transaction data associated with the transaction. For example, merchant system 108 may generate at least one clearing message (e.g., a plurality of clearing messages, a batch of clearing messages, and/or the like). Additionally or alternatively, merchant system 108 may communicate the clearing message(s) to acquirer system 110. Additionally or alternatively, acquirer system 110 may communicate the clearing message(s) to transaction service provider system 102. Additionally or alternatively, transaction service provider system 102 may communicate the clearing message(s) to issuer system 104. Additionally or alternatively, issuer system 104 may generate at least one settlement message based on the clearing message(s). Additionally or alternatively, issuer system 104 may communicate the settlement message(s) and/or funds to transaction service provider system 102 (and/or a settlement bank system associated with transaction service provider system 102). Additionally or alternatively, transaction service provider system 102 (and/or the settlement bank system) may communicate the settlement message(s) and/or funds to acquirer system 110, which may communicate the settlement message(s) and/or funds to merchant system 108 (and/or an account associated with merchant system 108).

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of environment 100 may perform one or more functions described as being performed by another set of systems or another set of devices of environment 100.

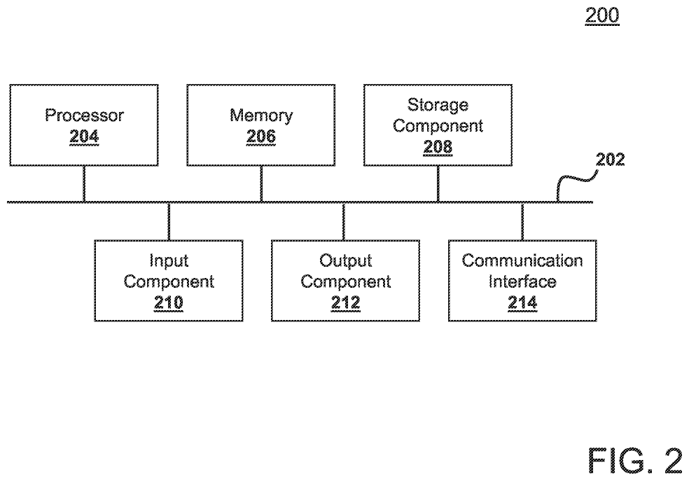

Referring now to FIG. 2, FIG. 2 is a diagram of example components of a device 200. Device 200 may correspond to one or more devices of transaction service provider system 102, one or more devices of issuer system 104, customer device 106, one or more devices of merchant system 108, one or more devices of acquirer system 110, and/or one or more devices of multi-task learning system 114. In some non-limiting embodiments or aspects, transaction service provider system 102, issuer system 104, customer device 106, merchant system 108, acquirer system 110, and/or multi-task learning system 114 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, software, firmware, and/or any combination thereof. For example, processor 204 may include a processor (e.g., a central processing unit (CPU), a graphics processing unit (GPU), an accelerated processing unit (APU), and/or the like), a microprocessor, a digital signal processor (DSP), and/or any processing component (e.g., a field-programmable gate array (FPGA), an application-specific integrated circuit (ASIC), and/or the like), and/or the like, which can be programmed to perform a function. Memory 206 may include random access memory (RAM), read-only memory (ROM), and/or another type of dynamic or static storage device (e.g., flash memory, magnetic memory, optical memory, and/or the like) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, a camera, and/or the like). Additionally or alternatively, input component 210 may include a sensor for sensing information (e.g., a global positioning system (GPS) component, an accelerometer, a gyroscope, an actuator, and/or the like). Output component 212 may include a component that provides output information from device 200 (e.g., a display, a speaker, one or more light-emitting diodes (LEDs), and/or the like).

Communication interface 214 may include a transceiver-like component (e.g., a transceiver, a receiver and transmitter that are separate, and/or the like) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a Bluetooth® interface, a Zigbee® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

In some non-limiting embodiments or aspects, a system may include at least one processor and at least one non-transitory computer-readable medium including one or more instructions that, when executed by the at least one processor, direct the at least one processor to perform any of the processes described herein.

In some non-limiting embodiments or aspects, a computer program product may include at least one non-transitory computer-readable medium including one or more instructions that, when executed by at least one processor, cause the at least one processor to perform any of the processes described herein.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

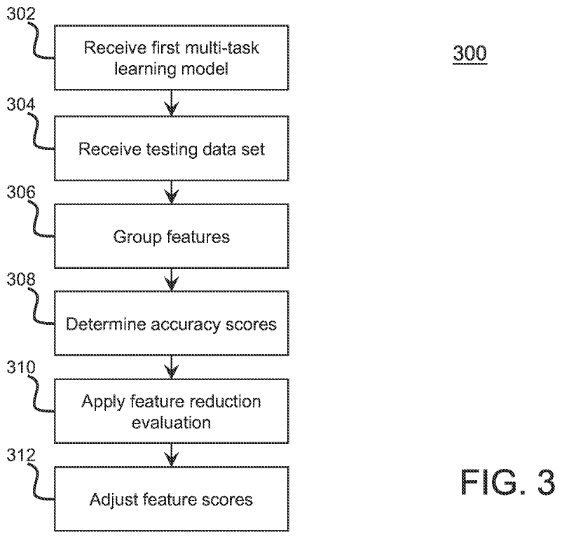

Referring now to FIG. 3, FIG. 3 is a flowchart of a non-limiting embodiment of a process 300 for multi-task learning in deep neural networks. In some non-limiting embodiments or aspects, one or more of the steps of process 300 may be performed (e.g., completely, partially, and/or the like) by multi-task learning system 114 (e.g., one or more devices of multi-task learning system 114). In some non-limiting embodiments or aspects, one or more of the steps of process 300 may be performed (e.g., completely, partially, and/or the like) by another system, another device, another group of systems, or another group of devices, separate from or including multi-task learning system 114, such as transaction service provider system 102 (e.g., one or more devices of transaction service provider system 102), issuer system 104 (e.g., one or more devices of issuer system 104), customer device 106, merchant system 108 (e.g., one or more devices of merchant system 108), and/or acquirer system 110 (e.g., one or more devices of acquirer system 110). In some non-limiting embodiments or aspects, with reference to FIG. 3, a multi-task learning platform may be a system (e.g., one or more devices) that is part of or associated with one or more multi-task learning systems 114 (e.g., a plurality of multi-task learning systems 114), a system (e.g., one or more devices) of a third party that is capable of receiving information from and/or communicating information to one or more multi-task learning systems 114 (e.g., a plurality of multi-task learning systems 114), or a system of (e.g., one or more devices) that is part of or associated with transaction service provider system 102 and is capable of receiving information from and/or communicating information to one or more multi-task learning systems 114 (e.g., a plurality of multi-task learning systems 114). Additionally or alternatively, the multi-task learning platform may be capable of receiving information from and/or communicating information to transaction service provider system 102, issuer system 104, customer device 106, merchant system 108, and/or acquirer system 110 via communication network 112.

As shown in FIG. 3, at step 302, process 300 may include receiving a first MTL model. In some non-limiting embodiments or aspects, a first MTL model associated with a first task and at least one second task may be received.

In some non-limiting embodiments or aspects, transaction service provider system 102 and/or multi-task learning system 114 may receive the first MTL model. In some non-limiting embodiments or aspects, the first MTL model may be configured to perform a first task and at least one second task.

In some non-limiting embodiments or aspects, before receiving the MTL model, multi-task learning system 114 may train the MTL model. For example, the MTL model may have shared hidden layers between the first task and the at least one second task. In some non-limiting embodiments or aspects, before receiving the MTL model, multi-task learning system 114 may train the MTL model, where the MTL model does not have shared hidden layers between the tasks (e.g., first task and second task(s)).

In some non-limiting embodiments or aspects, the first task may include generating, based on an authorization request, a first prediction associated with a likelihood of a first transaction amount in the authorization request matching a second transaction amount in at least one clearing message corresponding to the authorization request. Additionally or alternatively, the at least one second task may include at least one of generating, based on the authorization request, a second prediction associated with when the at least one clearing message will be received after the authorization message, generating, based on the authorization request, a third prediction associated with a number of clearing messages of the at least one clearing message, any combination thereof, and/or the like.

In some non-limiting embodiments or aspects, the first prediction may include a first score. In some non-limiting embodiments or aspects, the authorization request may be received (e.g., by transaction service provider system 102) from at least one of merchant system 108, acquirer system 110, and/or the like. Additionally or alternatively, transaction service provider system 102 and/or multi-task learning system 114 may generate, based on the authorization request, the first score associated with the likelihood of the first transaction amount in the authorization request matching the second transaction amount in the at least one clearing message corresponding to the authorization request. Additionally or alternatively, transaction service provider system 102 (and/or multi-task learning system 114) may insert the first score into at least one field of the authorization request to provide an enhanced authorization request. Additionally or alternatively, transaction service provider system 102 (and/or multi-task learning system 114) may communicate the enhanced authorization request to an issuer system.

In some non-limiting embodiments or aspects, issuer system 104 may determine to post a transaction associated with the authorization request to an account before receiving the clearing message corresponding to the authorization request based on the first score in the enhanced authorization request satisfying a threshold.

As shown in FIG. 3, at step 304, process 300 may include receiving a testing data set. For example, transaction service provider system 102 and/or multi-task learning system 114 may receive a testing data set.

In some non-limiting embodiments or aspects, the testing data set may include a plurality of testing data items for the MTL model. In some non-limiting embodiments or aspects, each testing data item may include a plurality of elements. Additionally or alternatively, each element may be associated with a respective feature of a plurality of features. In some non-limiting embodiments or aspects, multi-task learning system 114 (and/or transaction service provider system 102) may use the testing data set as input to one or more MTL models. For example, multi-task learning system 114 may use the testing data set as input to the MTL model.

As shown in FIG. 3, at step 306, process 300 may include grouping features. For example, multi-task learning system 114 (and/or transaction service provider system 102) may group a plurality of features into a plurality of groups. In some non-limiting embodiments or aspects, the features may be grouped into a plurality of groups based on an impact of each feature on the first task and the second task(s). Additionally or alternatively, at least one of an overall accuracy score, a first task accuracy score, and at least one second task accuracy score, any combination thereof, and/or the like may be determined based on inputting the testing data set to the first MTL model.

In some non-limiting embodiments or aspects, grouping the plurality of features into a plurality of groups may include training a second MTL model based on a subset of the testing data set, applying FRE based on the second MTL model and the subset of the testing data set to provide a first impact score for each feature of the plurality of features on the first task and at least one second impact score for each feature of the plurality of features on the at least one task, and grouping the plurality of features into the plurality of groups based on the first impact score and the at least one second impact score. In some non-limiting embodiments or aspects, the second MTL model may include an input layer, a first plurality of hidden layers associated with a first task, an output layer associated with the first task, at least one second plurality of hidden layers associated with the at least one second task, and at least one output layer associated with the at least one second task. For example, the second MTL model may not include any shared hidden layers (e.g., shared between the first task and the second task(s)). In some non-limiting embodiments or aspects, applying FRE may include removing a feature (e.g., replacing the element associated with the feature of each testing data item with a constant default value, such as 0, 1, the average value of elements associated with that feature among the testing data items, and/or the like), inputting the testing data items (with the feature removed) to the second MTL model, and determining a performance score (e.g., F score, F1 score, accuracy, and/or the like) for the first task (e.g., first task performance score) and the second task (e.g., second task performance scores) based on inputting the testing data items with the feature removed. This may be repeated for each feature of the plurality of features. In some non-limiting embodiments or aspects, the first and second impact scores for each respective feature may be determined based on the first and second performance scores, respectively, associated with the respective feature (e.g., the respective F1 score may be subtracted from 1 to provide the respective impact score and/or the like).

In some non-limiting embodiments or aspects, grouping the plurality of features into the plurality of groups based on the first impact score and the at least one second impact score may include ranking the plurality of features based on the first impact score of each feature of the plurality of features to provide a first ranking of the plurality of features, determining a first subset of features based on a first top portion of the first ranking of the plurality of features, determining a second subset of features comprising features of the plurality of features not in the first subset of features, ranking the plurality of features based on the at least one second impact score of each feature of the plurality of features to provide at least one second ranking of the plurality of features, determining at least one third subset of features based on at least one second top portion of the at least one second ranking of the plurality of features, determining at least one fourth subset of features comprising features of the plurality of features not in the at least one third subset of features, and grouping the plurality of features based on the first subset of features, the second subset of features, the at least one third subset of features, and the at least one fourth subset of features.

In some non-limiting embodiments or aspects, grouping the plurality of features based on the first subset of features, the second subset of features, the at least one third subset of features, and the at least one fourth subset of features may include determining a first group of the plurality of features based on the first subset and the at least one third subset, determining a second group of the plurality of features based on the first subset and the at least one fourth subset, determining a third group of the plurality of features based on the second subset and the at least one third subset, and determining a fourth group of the plurality of features based on the second subset and the at least one fourth subset.

As shown in FIG. 3, at step 308, process 300 may include determining accuracy scores. For example, multi-task learning system 114 (and/or transaction service provider system 102) may determine an overall accuracy score, a first task accuracy score, at least one second task accuracy score, any combination thereof, and/or the like. In some non-limiting embodiments or aspects, multi-task learning system 114 (and/or transaction service provider system 102) may determine accuracy scores based on inputting the testing data set to the first MTL model. In some non-limiting embodiments or aspects, multi-task learning system 114 may determine accuracy scores based on training the first MTL model, with the training data, on both the first task and the at least one second task and then inputting the testing data to generate the accuracy scores (e.g., overall accuracy score, first task accuracy score, and/or at least one second task accuracy score). For example, multi-task learning system 114 may train the first MTL model on both the first task and the at least one second task by sharing hidden layers between the tasks.

As shown in FIG. 3, at step 310, process 300 may include applying FRE. For example, multi-task learning system 114 (and/or transaction service provider system 102) may apply FRE to provide a feature score for each feature of the plurality of features in the testing data set. In some non-limiting embodiments or aspects, FRE may be applied based on the first MTL model and the testing data set to provide a feature score for each feature. In some non-limiting embodiments or aspects, applying FRE may include removing a feature (e.g., replacing the element associated with the feature of each testing data item with a constant default value, such as 0, 1, the average value of elements associated with that feature among the testing data items, and/or the like), inputting the testing data items (with the feature removed) to the first MTL model, and determining a performance score (e.g., F score, F1 score, accuracy, and/or the like) for the first task (e.g., first task performance score), the second task (e.g., second task performance scores), and/or overall performance (e.g., overall performance score) based on inputting the testing data items with the feature removed. This may be repeated for each feature of the plurality of features. In some non-limiting embodiments or aspects, the feature score for each respective feature may be determined based on the performance score (e.g., first, second, and/or overall performance score) associated with the respective feature (e.g., the respective F1 score may be subtracted from 1 to provide the respective feature score and/or the like).

As shown in FIG. 3, at step 312, process 300 may include adjusting feature scores. For example, multi-task learning system 114 may adjust the feature score of each respective feature of the plurality of features based on a respective grouping of the plurality of groupings associated with the respective feature. Additionally or alternatively, the feature score of each respective feature of the plurality of features may be adjusted based on at least one of the overall accuracy score, the first task accuracy score, the at least one second task accuracy score, any combination thereof, and/or the like to provide an adjusted feature score for the respective feature.

In some non-limiting embodiments or aspects, a subset of the plurality of features may be selected based on the adjusted feature score for each respective feature of the plurality of features. Additionally or alternatively, a second MTL model may be trained based on the subset of the plurality of features.

In some non-limiting embodiments or aspects, the adjusted feature score for each respective feature of the plurality of features may be communicated to a remote computing device.

In some non-limiting embodiments or aspects, adjusting the feature score of each respective feature of the plurality of features may include adjusting the feature score of each respective feature of the first group of the plurality of features based on the overall accuracy score to provide the adjusted feature score for the respective feature of the first group of the plurality of features, adjusting the feature score of each respective feature of the second group of the plurality of features based on the overall accuracy score and the at least one second task accuracy score to provide the adjusted feature score for the respective feature of the second group of the plurality of features, adjusting the feature score of each respective feature of the third group of the plurality of features based on the overall accuracy score and the first task accuracy score to provide the adjusted feature score for the respective feature of the third group of the plurality of features, and adjusting the feature score of each respective feature of the fourth group of the plurality of features based on the overall accuracy score, the first task accuracy score, and the at least one second task accuracy score to provide the adjusted feature score for the respective feature of the fourth group of the plurality of features.

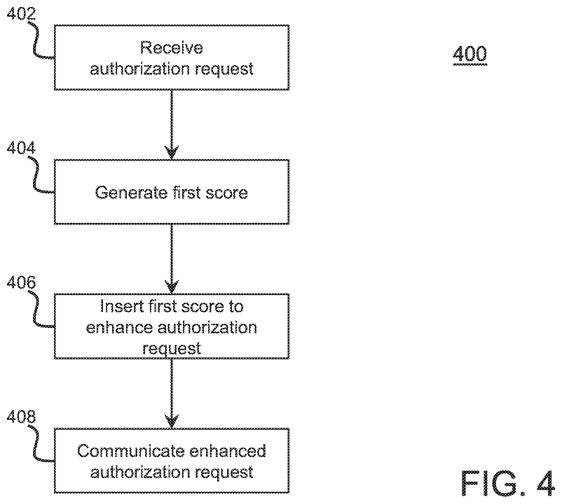

Referring now to FIG. 4, FIG. 4 is a flowchart of a non-limiting embodiment of a process 400 for enhancing an authorization request using multi-task learning in deep neural networks. In some non-limiting embodiments or aspects, one or more of the steps of process 400 may be performed (e.g., completely, partially, and/or the like) by transaction service provider system 102 (e.g., one or more devices of transaction service provider system 102, multi-task learning system 114 of transaction service provider system 102, and/or the like). In some non-limiting embodiments or aspects, one or more of the steps of process 400 may be performed (e.g., completely, partially, and/or the like) by another system, another device, another group of systems, or another group of devices, separate from or including transaction service provider system 102, such as issuer system 104 (e.g., one or more devices of issuer system 104), customer device 106, merchant system 108 (e.g., one or more devices of merchant system 108), acquirer system 110 (e.g., one or more devices of acquirer system 110), and/or multi-task learning system 114 (e.g., one or more devices of multi-task learning system 114). In some non-limiting embodiments or aspects, with reference to FIG. 4, a multi-task learning platform may be a system (e.g., one or more devices) that is part of or associated with one or more multi-task learning systems 114 (e.g., a plurality of multi-task learning systems 114), a system (e.g., one or more devices) of a third party that is capable of receiving information from and/or communicating information to one or more multi-task learning systems 114 (e.g., a plurality of multi-task learning systems 114), or a system of (e.g., one or more devices) that is part of or associated with transaction service provider system 102 and is capable of receiving information from and/or communicating information to one or more multi-task learning systems 114 (e.g., a plurality of multi-task learning systems 114). Additionally or alternatively, the multi-task learning platform may be capable of receiving information from and/or communicating information to transaction service provider system 102, issuer system 104, customer device 106, merchant system 108, and/or acquirer system 110 via communication network 112.

As shown in FIG. 4, at step 402, process 400 may include receiving an authorization request. In some non-limiting embodiments or aspects, an authorization request may be received (e.g., by transaction service provider system 102) from at least one of merchant system 108 and/or acquirer system 110.

As shown in FIG. 4, at step 404, process 400 may include generating a first score. For example, a first score may be generated (e.g., by transaction service provider system 102 and/or multi-task learning system 114), and the first score may be associated with a likelihood of a first transaction amount in the authorization request matching a second transaction amount in at least one clearing message corresponding to the authorization request.

In some non-limiting embodiments or aspects, based on the authorization request and a machine learning model (e.g., first MTL model of multi-task learning system 114 and/or the like), a first score associated with a likelihood of a first transaction amount in the authorization request matching a second transaction amount in at least one clearing message corresponding to the authorization request may be generated (e.g., by transaction service provider system 102 and/or multi-task learning system 114).

In some non-limiting embodiments or aspects, the machine learning model may include at least one of a deep neural network (DNN), an MTL model, any combination thereof (e.g., at least one MTL model with DNN structure), and/or the like.

As shown in FIG. 4, at step 406, process 400 may include inserting the first score. For example, the first score may be inserted (e.g., by transaction service provider system 102 and/or the like) into at least one field of the authorization request to provide an enhanced authorization request.

In some non-limiting embodiments or aspects, transaction service provider system 102 may insert the first score into at least one field of the authorization request to provide the enhanced authorization request.

As shown in FIG. 4, at step 408, process 400 may include communicating the enhanced authorization request. For example, the enhanced authorization request may be communicated from transaction service provider system 102 to issuer system 104. In some non-limiting embodiments or aspects, issuer system 104 may determine to post a transaction associated with the authorization request to an account before receiving the clearing message corresponding to the authorization request based on the first score in the enhanced authorization request satisfying a threshold.

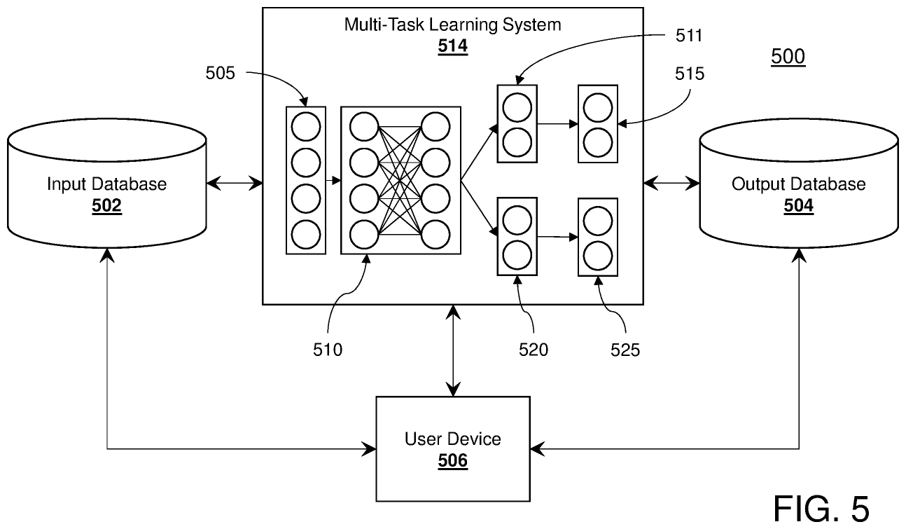

Referring now to FIG. 5, FIG. 5 is a diagram of a non-limiting embodiment of an implementation 500 of a non-limiting embodiment of process 300 shown in FIG. 3 and/or process 400 shown in FIG. 4. As shown in FIG. 5, implementation 500 may include input database 502, output database 504, user device 506, and multi-task learning system 514.

In some non-limiting embodiments or aspects, input database 502 may include a plurality of training data items and/or a plurality of testing data items for multi-task learning system 514, as described herein. In some non-limiting embodiments or aspects, each data item may include a plurality of elements, as described herein. Additionally or alternatively, each element may be associated with a respective feature of a plurality of features, as described herein. In some non-limiting embodiments or aspects, multi-task learning system 514 may use the data items from input database 502 as input to one or more MTL models. For example, multi-task learning system 514 may use the testing data items as input to the MTL model for testing and evaluation of the MTL model, as described herein. In some non-limiting embodiments or aspects, input database 502 and/or multi-task learning system 514 may receive the data items (e.g., training and/or testing data items) from user device 506.

In some non-limiting embodiments or aspects, input database 502 may include new testing data which has not been previously seen by (e.g., input to, processed by) multi-task learning system 514. In some non-limiting embodiments or aspects, the data items from input database 502 may be input to multi-task learning system 514 to evaluate the performance of the MTL model. In some non-limiting embodiments or aspects, testing data items from input database 502 may be input to multi-task learning system 514 to evaluate the individual performance of each of the first task, the at least one second task, and/or any additional tasks associated with the MTL model.

In some non-limiting embodiments or aspects, output database 504 may include one or more feature scores (e.g., a plurality of feature scores), one or more groupings (e.g., a plurality of groupings), one or more overall accuracy scores (e.g., a plurality of overall accuracy scores), one or more first task accuracy scores, (e.g., a plurality of first task accuracy scores), one or more second task accuracy scores, (e.g., a plurality of second task accuracy scores), one or more adjusted feature scores (e.g., a plurality of adjusted feature scores), one or more subsets of the plurality of features (e.g., a plurality of subsets), one or more first impact scores (e.g., a plurality of first impact scores), one or more second impact scores (e.g., a plurality of second impact scores), one or more groups of the plurality of features (e.g., a plurality of groups), one or more predictions (e.g., a plurality of predictions), any combination thereof, and/or the like, as described herein. For example, output database 504 may receive these outputs from multi-task learning system 514. In some non-limiting embodiments or aspects, multi-task learning system 514 and/or output database 504 may communicate such outputs (or any combination thereof) to user device 506.

In some non-limiting embodiments or aspects, user device 506 may be the same as or similar to customer device 106. Additionally or alternatively, user device 506 may include a device of issuer system 104, merchant system 108, acquirer system 110, and/or the like. In some non-limiting embodiments or aspects, user device 506 may be in communication with input database 502, output database 504, and/or multi-task learning system 514.

In some non-limiting embodiments or aspects, multi-task learning system 514 may include one or more machine learning models. In some non-limiting embodiments or aspects, the one or more machine learning models may include at least one MTL model. The one or more machine learning models may include one or more of a DNN, an MTL model, or any combination thereof. In some non-limiting embodiments or aspects, the one or more machine learning models may include input layer 505, one or more shared hidden layers 510, one or more first task hidden layers 511, first output layer 515, one or more second task hidden layers 520, and one or more second output layers 525. In some non-limiting embodiments or aspects, shared hidden layer(s) 510 may be associated with both the first task and the second task. In some non-limiting embodiments or aspects, first task hidden layer(s) 511 may be associated with the first task, and first output layer 515 may be associated with the first task. In some non-limiting embodiments or aspects, second task hidden layer(s) 520 may be associated with the second task(s), and second output layer(s) 525 may be associated with the second task(s). For example, if the MTL model performs three tasks, the at least one second task may include two “second” tasks (e.g., which could be referred to as a second task and a third task), and the MTL would include two sets of second task hidden layers 520 (e.g., one for the second task and one of the third task) and two second output layers 525 (e.g., one for the second task and one of the third task).

In some non-limiting embodiments or aspects, the one or more machine learning models may include a plurality of hidden layers associated with a plurality of tasks (e.g., more than a first task and a second task). In some non-limiting embodiments or aspects, the one or more machine learning models may include a plurality of output layers associated with a plurality of tasks (e.g., more than a first task and a second task).

In some non-limiting embodiments or aspects, multi-task learning system 514 may communicate with input database 502, output database 504, and/or user device 506. In some non-limiting embodiments or aspects, multi-task learning system 514 may receive data items from input database 502 as input to one or more machine learning models. In some non-limiting embodiments or aspects, multi-task learning system 514 may produce outputs, as described herein, which may be communicated to and/or stored in output database 504. In some non-limiting embodiments or aspects, multi-task learning system 514 may communicate output data to one or more other systems (e.g., user device 506 and/or the like). In some non-limiting embodiments or aspects, multi-task learning system 514 may be the same as or similar to multi-task learning system 114.

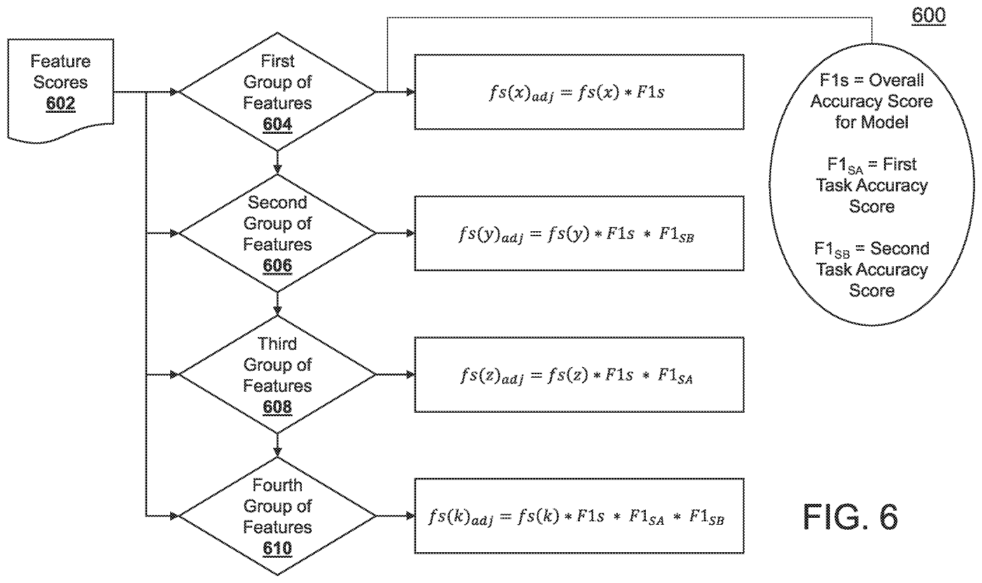

Referring now to FIG. 6, FIG. 6 is a diagram of a non-limiting embodiment of an implementation 600 of a non-limiting embodiment of process 300 shown in FIG. 3 and/or process 400 shown in FIG. 4. As shown in FIG. 6, implementation 600 may include feature scores 602, first group of features 604, second group of features 606, third group of features 608, and fourth group of features 610. In some non-limiting embodiments or aspects, feature scores 602 may correspond to each feature of the plurality of features. In some non-limiting embodiments or aspects, feature scores 602 may correspond to each feature of first group of features 604, each feature of second group of features 606, each feature of third group of features 608, and/or each feature of fourth group of features 610.

In some non-limiting embodiments or aspects, the adjusted feature score of each respective feature of first group of features 604 may be based on the overall accuracy score for the respective feature of first group of features 604. For example, each feature score of each respective feature of first group of features 604 (e.g., fs(x)) may be multiplied by the overall accuracy score (e.g., F1s) to adjust each feature score of each respective feature of first group of features 604.

In some non-limiting embodiments or aspects, the adjusted feature score of each respective feature of second group of features 606 may be based on the overall accuracy score and at least one second task accuracy score for the respective feature of second group of features 606. For example, each feature score of each respective feature of second group of features 606 (e.g., fs(y)) may be multiplied by the overall accuracy score (e.g., F1s) and multiplied by at least one second task accuracy score (e.g., F1_{SB}) to adjust each feature score of each respective feature of second group of features 606.

In some non-limiting embodiments or aspects, the adjusted feature score of each respective feature of third group of features 608 may be based on the overall accuracy score and the first task accuracy score for the respective feature of third group of features 608. For example, each feature score of each respective feature of third group of features 608 (e.g., fs(z)) may be multiplied by the overall accuracy score (e.g., F1s) and multiplied by the first task accuracy score (e.g., F1_{SA}) to adjust each feature score of each respective feature of third group of features 608.

In some non-limiting embodiments or aspects, the adjusted feature score of each respective feature of fourth group of features 610 may be based on the overall accuracy score, the first task accuracy score, and at least one second task accuracy score for the respective feature of fourth group of features 610. For example, each feature score of each respective feature of fourth group of features 610 (e.g., fs(k)) may be multiplied by the overall accuracy score (e.g., F1s), multiplied by the first task accuracy score (e.g., F1_{SA}), and multiplied by at least one second task accuracy score (e.g., F1_{SB}) to adjust each feature score of each respective feature of fourth group of features 610.

In some non-limiting embodiments or aspects, when a group of features of the plurality of features is empty (e.g., does not contain any features, the group does not exist, etc.), the adjusted feature score for that group is not calculated and adjusting of the next group of features of the plurality of features may proceed.

In some non-limiting embodiments or aspects, the overall accuracy score may be determined based on a measure of overall MTL model performance. In some non-limiting embodiments or aspects, the measure of overall MTL model performance may be generated based on inputting the testing data set to the first MTL model. For example, the overall accuracy score may be determined based on the combined performance of the first task and the at least one second task on the testing data set.

In some non-limiting embodiments or aspects, the first task accuracy score and the at least one second task accuracy score may be determined based on a measure of MTL model performance for each individual task. In some non-limiting embodiments or aspects, the measure of MTL model performance for each individual task may be generated based on inputting the testing data set to the first MTL model. For example, the first task accuracy score may be determined based on a measure of MTL model performance for the first task individually on the testing data set. The at least one second task accuracy score may be determined based on a measure of MTL model performance for the at least one second task individually on the testing data set.

In some non-limiting embodiments or aspects, the adjusted feature score may include the final feature score. In some non-limiting embodiments or aspects, the final feature score may be determined based on additional processing of the adjusted feature score.

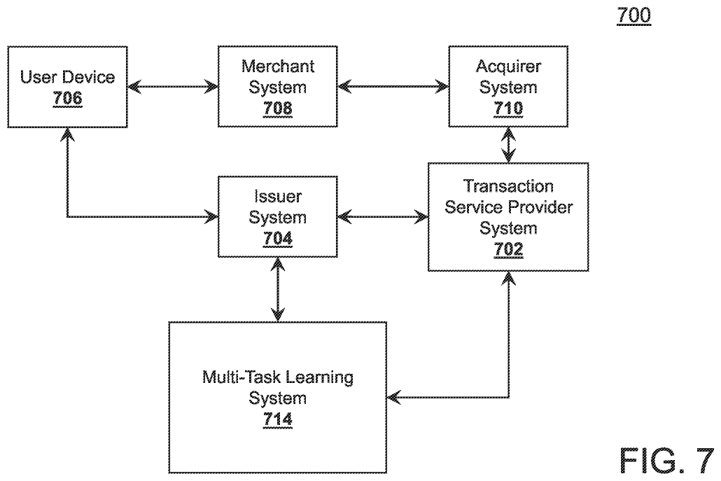

Referring now to FIG. 7, FIG. 7 is a diagram of a non-limiting embodiment of an implementation 700 of a non-limiting embodiment of process 300 shown in FIG. 3 and/or process 400 shown in FIG. 4. As shown in FIG. 7, implementation 700 may include transaction service provider system 702, issuer system 704, user device 706, merchant system 708, acquirer system 710, and multi-task learning system 714.

In some non-limiting embodiments or aspects, transaction service provider system 702 may be associated with a transaction service provider as described herein. In some non-limiting embodiments or aspects, transaction service provider system 702 may include multi-task learning system 714. In some non-limiting embodiments or aspects, transaction service provider system 702 may communicate with one or more of issuer system 704, acquirer system 710, and/or multi-task learning system 714. In some non-limiting embodiments or aspects, transaction service provider system 702 may be the same as or similar to transaction service provider system 102.

In some non-limiting embodiments or aspects, issuer system 704 may be associated with an issuer institution as described herein. In some non-limiting embodiments or aspects, issuer system 704 may communicate with one or more of transaction service provider system 702, user device 706, and/or multi-task learning system 714. In some non-limiting embodiments or aspects, issuer system 704 may be the same as or similar to issuer system 104.

In some non-limiting embodiments or aspects, user device 706 may include a portable financial device as described herein. In some non-limiting embodiments or aspects, user device 706 may communicate with one or more of issuer system 704 and/or merchant system 708. In some non-limiting embodiments or aspects, user device 706 may be the same as or similar to customer device 106.

In some non-limiting embodiments or aspects, merchant system 708 may be associated with a merchant as described herein. In some non-limiting embodiments or aspects, merchant system 708 may communicate with one or more of user device 706 and/or acquirer system 710. In some non-limiting embodiments or aspects, merchant system 708 may be the same as or similar to merchant system 108.

In some non-limiting embodiments or aspects, acquirer system 710 may be associated with an acquirer as described herein. In some non-limiting embodiments or aspects, acquirer system 710 may be in communication with one or more of transaction service provider system 702 and/or merchant system 708. In some non-limiting embodiments or aspects, acquirer system 710 may be the same as or similar to acquirer system 110.

In some non-limiting embodiments or aspects, multi-task learning system 714 may include one or more machine learning models. In some non-limiting embodiments or aspects, the one or more machine learning models may include at least one MTL model. The one or more machine learning models may include one or more of a DNN, an MTL model, or any combination thereof.

In some non-limiting embodiments or aspects, multi-task learning system 714 may be the same as, similar to, or a part of transaction service provider system 702. In some non-limiting embodiments or aspects, multi-task learning system 714 may be associated with a transaction service provider as described herein. In some non-limiting embodiments or aspects, multi-task learning system 714 may be the same as or similar to multi-task learning system 114 and/or multi-task learning system 514.

As an example, merchant system 708 may generate an authorization request based on a customer transaction using user device 706 (e.g., at a POS device, e-commerce, and/or the like). Merchant system 708 may communicate the authorization request to acquirer system 710. Acquirer system 710 may receive the authorization request and may communicate the authorization request to transaction service provider system 702. Transaction service provider system 702 may communicate the authorization request to multi-task learning system 714. In some non-limiting embodiments or aspects, multi-task learning system 714 may be part of transaction service provider system 702. In some non-limiting embodiments or aspects, multi-task learning system 714 may be a separate system from transaction service provider system 702.

Once the authorization request is received by multi-task learning system 714, multi-task learning system 714 may process the authorization request by inputting the authorization request (or at least one input data item based thereon) to a machine learning model (e.g., MTL model) of multi-task learning system 714. In some non-limiting embodiments or aspects, multi-task learning system 714 may input the authorization request (or at least one input data item based thereon) to a machine learning model to generate at least one score (e.g., a first score associated with a first task, at least one second score associated with at least one second task, and/or the like). For example, multi-task learning system 714 may input the authorization request (or at least one input data item based thereon) to a machine learning model to generate a first score associated with a likelihood of a first transaction amount in the authorization request matching a second transaction amount in a clearing message corresponding to the authorization request. Additionally or alternatively, multi-task learning system 714 may input the authorization request (or at least one input data item based thereon) to a machine learning model to generate a second score representing a risk associated with the transaction which may be used to clear the transaction or redirect the transaction for further processing. In some non-limiting embodiments or aspects, multi-task learning system 714 may communicate the first score to transaction service provider system 702. In some non-limiting embodiments or aspects, multi-task learning system 714 may communicate the first score directly to issuer system 704. In some non-limiting embodiments or aspects, transaction service provider system 702 and/or multi-task learning system 714 may insert the first score (and/or second score) into at least one field of the authorization request to enhance the authorization request (e.g., generate an enhanced authorization request).

In some non-limiting embodiments or aspects, transaction service provider system 702 (and/or multi-task learning system 714) may communicate the enhanced authorization request to issuer system 704. In some non-limiting embodiments or aspects, issuer system 704 may receive the enhanced authorization request. In some non-limiting embodiments or aspects, issuer system 704 may receive the score(s) associated with the enhanced authorization request (e.g., may extract the score(s) (e.g., first score, second score, and/or the like) from the field(s) of the authorization request). For example, issuer system 704 may receive the first score from the enhanced authorization request and/or use the first score as a measure for making a posting decision associated with the transaction.

In some non-limiting embodiments or aspects, issuer system 704 may determine to post a transaction associated with the authorization request to an account before receiving the clearing message corresponding to the authorization request based on the first score in the enhanced authorization request satisfying a threshold.

In some non-limiting embodiments or aspects, issuer system 704 may communicate a message to user device 706 associated with the enhanced authorization request. For example, issuer system 704 may communicate a message to user device 706 that contains details corresponding to a posting decision associated with the transaction. As a further example, issuer system 704 may communicate a message to user device 706 indicating that the transaction associated with the enhanced authorization request has posted and/or cleared.

Although the disclosed subject matter has been described in detail for the purpose of illustration based on what is currently considered to be the most practical and preferred embodiments or aspects, it is to be understood that such detail is solely for that purpose and that the disclosed subject matter is not limited to the disclosed embodiments or aspects, but, on the contrary, is intended to cover modifications and equivalent arrangements that are within the spirit and scope of the appended claims. For example, it is to be understood that the presently disclosed subject matter contemplates that, to the extent possible, one or more features of any embodiment or aspect can be combined with one or more features of any other embodiment or aspect.

What is claimed is:

1. A computer-implemented method, comprising:
receiving, with at least one processor, a first multi-task learning model associated with a first task and at least one second task;
receiving, with the at least one processor, a testing data set comprising a plurality of testing data items for the first multi-task learning model, each testing data item comprising a plurality of elements, each element of the plurality of elements associated with a respective feature of a plurality of features;
grouping, with the at least one processor, the plurality of features into a plurality of groups based on an impact of each feature of the plurality of features on the first task and the at least one second task;
determining, with the at least one processor, an overall accuracy score, a first task accuracy score, and at least one second task accuracy score based on inputting the testing data set to the first multi-task learning model;
applying, with the at least one processor, feature reduction evaluation (FRE) based on the first multi-task learning model and the testing data set to provide a feature score for each feature of the plurality of features; and
adjusting, with the at least one processor, the feature score of each respective feature of the plurality of features based on a respective grouping of the plurality of groupings associated with the respective feature and at least one of the overall accuracy score, the first task accuracy score, the at least one second task accuracy score, or a combination thereof to provide an adjusted feature score for the respective feature.

2. The computer-implemented method of claim 1, further comprising selecting, with the at least one processor, a subset of the plurality of features based on the adjusted feature score for each respective feature of the plurality of features.

3. The computer-implemented method of claim 2, further comprising training, with the at least one processor, a second multi-task learning model based on the subset of the plurality of features.

4. The computer-implemented method of claim 1, further comprising communicating, with the at least one processor, the adjusted feature score for each respective feature of the plurality of features to a remote computing device.

5. The computer-implemented method of claim 1, wherein grouping the plurality of features into a plurality of groups comprises:
training, with the at least one processor, a second multi-task learning model based on a subset of the testing data set;
applying, with the at least one processor, FRE based on the second multi-task learning model and the subset of the testing data set to provide a first impact score for each feature of the plurality of features on the first task and at least one second impact score for each feature of the plurality of features on the at least one second task; and
grouping, with the at least one processor, the plurality of features into the plurality of groups based on the first impact score and the at least one second impact score.

6. The computer-implemented method of claim 5, wherein the second multi-task learning model comprises an input layer, a first plurality of hidden layers associated with the first task, an output layer associated with the first task, at least one second plurality of hidden layers associated with the at least one second task, and at least one output layer associated with the at least one second task.

7. The computer-implemented method of claim 5, wherein grouping the plurality of features into the plurality of groups based on the first impact score and the at least one second impact score comprises:
ranking, with the at least one processor, the plurality of features based on the first impact score of each feature of the plurality of features to provide a first ranking of the plurality of features;
determining, with the at least one processor, a first subset of features based on a first top portion of the first ranking of the plurality of features;
determining, with the at least one processor, a second subset of features comprising features of the plurality of features not in the first subset of features;
ranking, with the at least one processor, the plurality of features based on the at least one second impact score of each feature of the plurality of features to provide at least one second ranking of the plurality of features;
determining, with the at least one processor, at least one third subset of features based on at least one second top portion of the at least one second ranking of the plurality of features;
determining, with the at least one processor, at least one fourth subset of features comprising features of the plurality of features not in the at least one third subset of features; and
grouping, with the at least one processor, the plurality of features based on the first subset of features, the second subset of features, the at least one third subset of features, and the at least one fourth subset of features.

8. The computer-implemented method of claim 7, wherein grouping the plurality of features based on the first subset of features, the second subset of features, the at least one third subset of features, and the at least one fourth subset of features comprises:
determining, with the at least one processor, a first group of the plurality of features based on the first subset and the at least one third subset;
determining, with the at least one processor, a second group of the plurality of features based on the first subset and the at least one fourth subset;
determining, with the at least one processor, a third group of the plurality of features based on the second subset and the at least one third subset; and
determining, with the at least one processor, a fourth group of the plurality of features based on the second subset and the at least one fourth subset.

9. The computer-implemented method of claim 8, wherein adjusting the feature score of each respective feature of the plurality of features comprises:
adjusting, with the at least one processor, the feature score of each respective feature of the first group of the plurality of features based on the overall accuracy score to provide the adjusted feature score for the respective feature of the first group of the plurality of features;
adjusting, with the at least one processor, the feature score of each respective feature of the second group of the plurality of features based on the overall accuracy score and the at least one second task accuracy score to provide the adjusted feature score for the respective feature of the second group of the plurality of features;
adjusting, with the at least one processor, the feature score of each respective feature of the third group of the plurality of features based on the overall accuracy score and the first task accuracy score to provide the adjusted feature score for the respective feature of the third group of the plurality of features; and
adjusting, with the at least one processor, the feature score of each respective feature of the fourth group of the plurality of features based on the overall accuracy score, the first task accuracy score, and the at least one second task accuracy score to provide the adjusted feature score for the respective feature of the fourth group of the plurality of features.

10. The computer-implemented method of claim 1, wherein the first task comprises generating, based on an authorization request, a first prediction associated with a likelihood of a first transaction amount in the authorization request matching a second transaction amount in at least one clearing message corresponding to the authorization request.

11. The computer-implemented method of claim 10, wherein the at least one second task comprises at least one of generating, based on the authorization request, a second prediction associated with when the at least one clearing message will be received after the authorization message, generating, based on the authorization request, a third prediction associated with a number of clearing messages of the at least one clearing message, or any combination thereof.

12. The computer-implemented method of claim 10, wherein the first prediction comprises a first score.

13. The computer-implemented method of claim 12, further comprising:
receiving, with the at least one processor, the authorization request from at least one of a merchant system or an acquirer system;
generating, with the at least one processor, based on the authorization request, the first score associated with the likelihood of the first transaction amount in the authorization request matching the second transaction amount in the at least one clearing message corresponding to the authorization request;
inserting, with the at least one processor, the first score into at least one field of the authorization request to provide an enhanced authorization request; and
communicating, with the at least one processor, the enhanced authorization request to an issuer system.

14. The computer-implemented method of claim 13, wherein generating the first score comprises:
determining, with the at least one processor, a first plurality of elements based on the authorization request, each element of the first plurality of elements associated with a first respective feature of the plurality of features; and
inputting, with the at least one processor, the first plurality of elements to the first multi-task learning model to generate the first score associated with the likelihood of the first transaction amount in the authorization request matching the second transaction amount in the at least one clearing message corresponding to the authorization request.

15. The computer-implemented method of claim 13, further comprising determining, with the at least one processor, based on the authorization request, that the issuer system is enrolled in a program before generating the first score.

16. The computer-implemented method of claim 15, wherein generating the first score, inserting the first score into the at least one field of the authorization request to provide the enhanced authorization request, and communicating the enhanced authorization request are in response to determining that the issuer is enrolled in the program.

17. The computer-implemented method of claim 13, wherein the issuer system determines to post a transaction associated with the authorization request to an account before receiving the clearing message corresponding to the authorization request based on the first score in the enhanced authorization request satisfying a threshold.

18. A computer-implemented method, comprising:
receiving, with at least one processor, an authorization request from at least one of a merchant system or an acquirer system;
generating, with the at least one processor, based on the authorization request and a machine learning model, a first score associated with a likelihood of a first transaction amount in the authorization request matching a second transaction amount in at least one clearing message corresponding to the authorization request;
inserting, with the at least one processor, the first score into at least one field of the authorization request to provide an enhanced authorization request; and
communicating, with the at least one processor, the enhanced authorization request to an issuer system.

19. The computer-implemented method of claim 18, wherein the machine learning model comprises at least one of a deep neural network (DNN), a multi-task learning model, or any combination thereof.

20. A system, comprising:
at least one processor; and
at least one non-transitory computer-readable medium including one or more instructions that, when executed by the at least one processor, direct the at least one processor to:
receive a first multi-task learning model associated with a first task and at least one second task;
receive a testing data set comprising a plurality of testing data items for the first multi-task learning model, each testing data item comprising a plurality of elements, each element of the plurality of elements associated with a respective feature of a plurality of features;
group the plurality of features into a plurality of groups based on an impact of each feature of the plurality of features on the first task and the at least one second task;
determine an overall accuracy score, a first task accuracy score, and at least one second task accuracy score based on inputting the testing data set to the first multi-task learning model;
apply feature reduction evaluation (FRE) based on the first multi-task learning model and the testing data set to provide a feature score for each feature of the plurality of features; and
adjust the feature score of each respective feature of the plurality of features based on a respective grouping of the plurality of groupings associated with the respective feature and at least one of the overall accuracy score, the first task accuracy score, the at least one second task accuracy score, or a combination thereof to provide an adjusted feature score for the respective feature.
